(19) United States
(12) Patent Application Publication
(10) Pub. No.: US 2017/0218201 A1
(43) Pub. Date: Aug. 3, 2017

(54) BIOMASS COMPOSITIONS AND METHODS FOR THEIR PREPARATION

(71) Applicant: Shanghai Zhiyi Information Technology Ltd, Shanghai (CN)

(72) Inventor: Yanmin GAO, Zhenjiang (CN)

(73) Assignee: Shanghai Zhiyi Information Technology Ltd, Shanghai (CN)

(21) Appl. No.: 15/502,640

(22) PCT Filed: Aug. 8, 2014
(86) PCT No.: PCT/CN2014/083988

§ 371 Date: Feb. 8, 2017

(51) Int. Cl. C08L 97/02; C08B 37/00

(52) U.S. Cl. CPC C08L 97/02; C08B 37/0096; C08L 2201/06

(57) ABSTRACT

Described herein are compositions including a first polysaccharide having at least one substituent selected from —(CH₂)ₚO—X and —O—(CH₂)_{q}—X, wherein X is —COOH, —NH₂, or C₂-C₁₀ alkenyl, each p is independently an integer of 0-10, and each q is independently an integer of 0-10, a second polysaccharide having at least one substituent selected from —(CH₂)ₛO—Y and —O—(CH₂)ₜ—Y, wherein Y is

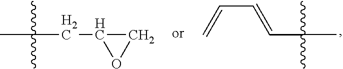

each s is independently an integer of 0-10, and each t is independently an integer of 0-10, wherein the first polysaccharide and the second polysaccharide are coupled to each other through at least one crosslink formed between at least one X and at least one Y, and at least one of the following: at least one fiber reinforcing material, at least one curing accelerator, at least one coupling agent, or combinations thereof. Also described are methods of making such compositions and articles made of such compositions.

### BACKGROUND

A large amount of waste dumped in landfills include items such as packaging and containers that are usually made of non-biodegradable materials such as plastics, metals and glass. The widespread use of such materials contributes to problems such as increased landfill burdens, increased toxic emissions to the environment, and increased use of non-renewable resources. Thus, there is a need for alternative materials to replace the non-biodegradable materials found in packaging and containers. The alternative materials would desirably be biodegradable and hence help alleviate the economic and environmental problems caused by non-biodegradable wastes.

### SUMMARY

In an embodiment, a composition includes (1) a first polysaccharide having at least one substituent selected from —(CH₂)ₚO—X and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10, and (2) a second polysaccharide having at least one substituent selected from —(CH₂)ₛO—Y and —O—(CH₂)ₜ—Y, wherein Y is

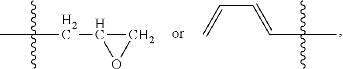

each s is independently an integer of 0, 1, 2, 3, 4, 5, 6, 7, 8, 9, or 10, and each t is independently an integer of 0, 1, 2, 3, 4, 5, 6, 7, 8, 9, or 10; wherein the first polysaccharide and the second polysaccharide are coupled to each other through at least one crosslink formed between at least one X and at least one Y.

In an embodiment, a composition includes (1) a first polysaccharide having at least one substituent selected from —(CH₂)ₚO—X, and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10, (2) a second polysaccharide having at least one substituent selected from —(CH₂)ₛO—Y, and —O—(CH₂)ₜ—Y, wherein Y is

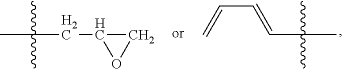

each s is independently an integer of 0, 1, 2, 3, 4, 5, 6, 7, 8, 9, or 10, and each t is independently an integer of 0, 1, 2, 3, 4, 5, 6, 7, 8, 9, or 10; wherein the first polysaccharide and the second polysaccharide are coupled to each other through at least one crosslink formed between at least one X and at least one Y; (3) at least one reinforcing material, (4) at least one curing accelerator, and (5) at least one coupling agent.

In an embodiment, a method of preparing a biomass composition includes (1) contacting (a) a first polysaccharide having at least one substituent selected from —(CH₂)ₚO—X and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10, and (b) a second polysaccharide comp

rising at least one substituent selected from —(CH₂)ₛO—Y and —O—(CH₂)ₜ—Y, wherein Y is

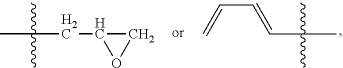

each s is independently an integer of 0, 1, 2, 3, 4, 5, 6, 7, 8, 9, or 10, and each t is independently an integer of 0, 1, 2, 3, 4, 5, 6, 7, 8, 9, or 10, to form a starting material; (2) heating the starting material, wherein the heating couples the first polysaccharide to the second polysaccharide through at least one crosslink formed between at least one X and at least one Y; and adding at least one fiber reinforcing material, at least one curing accelerator, and at least one coupling agent, resulting in the formation of a biomass composition.

In an embodiment, an article is made from a composition including (1) a first polysaccharide including at least one substituent selected from —(CH₂)ₚO—X and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10, and (2) a second polysaccharide comprising at least one substituent selected from —(CH₂)ₛO—Y and —O—(CH₂)ₜ—Y, wherein Y is

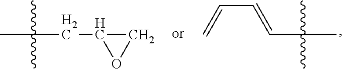

each s is independently an integer of 0, 1, 2, 3, 4, 5, 6, 7, 8, 9, or 10, and each t is independently an integer of 0, 1, 2, 3, 4, 5, 6, 7, 8, 9, or 10; wherein the first polysaccharide and the second polysaccharide are coupled to each other through at least one crosslink formed between at least one X and at least one Y.

### DETAILED DESCRIPTION

The technology described herein generally relates to compositions, and methods of making the compositions, for use in, for example but are not limited to, packaging and containers. The compositions can be environmentally friendlier relative to the non-biodegradable materials that are currently in use. The non-biodegradable materials found in packaging and containers, are typically synthetic organic substances that do not biodegrade into their base components. Although alternative materials that degrade more readily than the synthetic materials have been provided, they generally have unstable physical properties, and may be derived from materials that are high in cost and hence are economically unattractive for broad use.

Compositions described herein, and thus articles such as packaging and containers made therefrom, are biodegradable. The compositions described herein can be prepared using biomass waste materials. The compositions may also have good tensile property.

The compositions described herein generally include a first polysaccharide and a second polysaccharide coupled to one another. Some embodiments further include at least one of the following: at least one reinforcing material, at least one curing accelerator, at least one coupling agent, or combinations thereof.

In some embodiments, a first polysaccharide has at least one substituent selected from —(CH₂)ₚO—X and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10. In some embodiments, X is —COOH.

In some embodiments, the first polysaccharide is of formula (I):

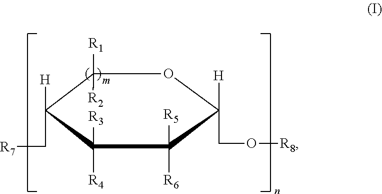

wherein each R₁, R₂, R₃, R₄, R₅, R₆ and R₇ is independently selected from a polysaccharide of formula (I), a hydrogen, a hydroxyl group, a carboxyl group, an amino group, —O—, a straight or branched C₁-C₁₀ alkyl, a straight or branched C₂-C₁₀ alkenyl, a straight or branched C₂-C₁₀ alkynyl, a straight or branched C₁-C₁₀ heteroalkyl, a straight or branched C₂-C₁₀ heteroalkenyl, and a straight or branched C₂-C₁₀ heteroalkynyl, wherein each hydroxyl group, carboxyl group, amino group, —O—, straight or branched C₁-C₁₀ alkyl, straight or branched C₂-C₁₀ alkenyl, straight or branched C₂-C₁₀ alkynyl, straight or branched C₁-C₁₀ heteroalkyl, straight or branched C₂-C₁₀ heteroalkenyl, and straight or branched C₂-C₁₀ heteroalkynyl is substituted or unsubstituted,

wherein each R₈ is independently selected from a polysaccharide of formula (I), a hydrogen, a hydroxyl group, a carboxyl group, an amino group, a straight or branched C₁-C₁₀ alkyl, a straight or branched C₂-C₁₀ alkenyl, a straight or branched C₂-C₁₀ alkynyl, a straight or branched C₁-C₁₀ heteroalkyl, a straight or branched C₂-C₁₀ heteroalkenyl, and a straight or branched C₂-C₁₀ heteroalkynyl, wherein each hydroxyl group, carboxyl group, amino group, straight or branched C₁-C₁₀ alkyl, straight or branched C₂-C₁₀ alkenyl, straight or branched C₂-C₁₀ alkynyl, straight or branched C₁-C₁₀ heteroalkyl, straight or branched C₂-C₁₀ heteroalkenyl, and straight or branched C₂-C₁₀ heteroalkynyl is substituted or unsubstituted,

wherein each m is independently an integer of 0 or 1, and

wherein each n is independently an integer of 1 to 10. In some embodiments, each n is independently an integer of 1 to 3. In some embodiments, each n is independently an integer of 1, 3, 10, or any integer or range of integers between 1 and 10, including endpoints. In some embodiments, each straight or branched C₁-C₁₀ heteroalkyl, straight or branched C₂-C₁₀ heteroalkenyl, and straight or branched C₂-C₁₀ heteroalkynyl has 1, 2, or 3 carbons replaced by one or more heteroatom selected from O, N, and S. In some embodiments, m is 0 and R₁ and R₂ are both absent.

In some embodiments, the first polysaccharide is a homopolysaccharide. As used herein, “homopolysaccharide” refers to a polysaccharide composed of only one kind of monosaccharide. In some embodiments, the first polysaccharide is a heteropolysaccharide. As used herein, “heteropolysaccharide” refers to a polysaccharide composed of more than one type of monosaccharide.

In some embodiments, the first polysaccharide is biomass-derived. As used herein, “biomass-derived” refers to a material that is derived from a biological material from living or non-living organisms. In some embodiments, the first polysaccharide is a food gum. In some embodiments, the first polysaccharide is a derivative of at least one of arabic gum, locust bean gum, guar gum, carrageenan, konjac glucomannan, flaxseed gum, tamarind gum, or combinations thereof.

In some embodiments, the first polysaccharide is present in the composition in an amount of about 5% to about 25% by mass, for example about 5%, about 10%, about 15%, about 20%, about 25% by mass or a percentage by mass between any of these values. In some embodiments, the first polysaccharide is present in the composition in an amount of about 15%. In some embodiments, the first polysaccharide is a powder. In some embodiments, the powder has an average particle diameter of about 5 microns to about 10 microns, for example about 5 microns, about 6 microns, about 7 microns, about 8 microns, about 9 microns, about 10 microns or an average particle diameter between any of these values.

In some embodiments, a second polysaccharide has at least one substituent selected from —(CH₂)ₛO—Y and —O—(CH₂)ₜ—Y, wherein Y is

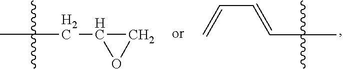

each s is independently an integer of 0, 1, 2, 3, 4, 5, 6, 7, 8, 9, or 10, and each t is independently an integer of 0, 1, 2, 3, 4, 5, 6, 7, 8, 9, or 10. In some embodiments, Y is

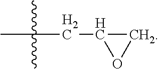 [SMILES: *CC1CO1]

In some embodiments, X is —COOH and Y is

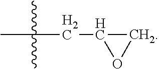 [SMILES: *CC1CO1]

In some embodiments, the second polysaccharide is of formula (II):

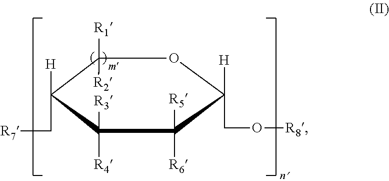

wherein each R_{1′}, R_{2′}, R_{3′}, R_{4′}, R_{5′}, R_{6′}, and R_{7′} is independently selected from a polysaccharide of formula (II), a hydrogen, a hydroxyl group, an epoxide, a (C₁-C₁₀ alkyl)-epoxide, —O—, a straight or branched C₁-C₁₀ alkyl, a straight or branched C₂-C₁₀ alkenyl, a straight or branched C₂-C₁₀ alkynyl, a straight or branched C₁-C₁₀ heteroalkyl, a straight or branched C₂-C₁₀ heteroalkenyl, and a straight or branched C₂-C₁₀ heteroalkynyl, wherein each hydroxyl group, carboxyl group, amino group, —O—, straight or branched C₁-C₁₀ alkyl, straight or branched C₂-C₁₀ alkenyl, straight or branched C₂-C₁₀ alkynyl, straight or branched C₁-C₁₀ heteroalkyl, straight or branched C₂-C₁₀ heteroalkenyl, and straight or branched C₂-C₁₀ heteroalkynyl is substituted or unsubstituted, wherein each R_{8′} is independently selected from a polysaccharide of formula (II), a hydrogen, a hydroxyl group, an epoxide, a (C₁-C₁₀ alkyl)-epoxide, a straight or branched C₁-C₁₀ alkyl, a straight or branched C₂-C₁₀ alkenyl, a straight or branched C₂-C₁₀ alkynyl, a straight or branched C₁-C₁₀ heteroalkyl, a straight or branched C₂-C₁₀ heteroalkenyl, and a straight or branched C₂-C₁₀ heteroalkynyl, wherein each hydroxyl group, carboxyl group, amino group, straight or branched C₁-C₁₀ alkyl, straight or branched C₂-C₁₀ alkenyl, straight or branched C₂-C₁₀ alkynyl, straight or branched C₁-C₁₀ heteroalkyl, straight or branched C₂-C₁₀ heteroalkenyl, and straight or branched C₂-C₁₀ heteroalkynyl is substituted or unsubstituted, wherein each m′ is independently an integer of 0 or 1, and wherein each n′ is independently an integer of 1 to 10. In some embodiments, each n′ is independently an integer of 1 to 3. In some embodiments, each n′ is independently an integer of 1, 3, 10, or any integer or range of integers between 1 and 10, including endpoints. In some embodiments, each straight or branched C₁-C₁₀ heteroalkyl, straight or branched C₂-C₁₀ heteroalkenyl, and straight or branched C₂-C₁₀ heteroalkynyl has 1, 2, or 3 carbons replaced by one or more heteroatom selected from 0, N, and S. In some embodiments, m′ is 0 and R₁ and R₂ are both absent.

In some embodiments, the second polysaccharide is a homopolysaccharide. In some embodiments, the second polysaccharide is a heteropolysaccharide.

In some embodiments, the second polysaccharide is biomass-derived. In some embodiments, the second polysaccharide is a food gum. In some embodiments, the second polysaccharide is a derivative of at least one of arabic gum, locust bean gum, guar gum, carrageenan, konjac glucomannan, flaxseed gum, tamarind gum, or combinations thereof.

In some embodiments, the second polysaccharide is present in the composition in an amount of about 5% to about 25% by mass, for example about 5%, about 10%, about 15%, about 20%, about 25% by mass or a percentage by mass between any of these values. In some embodiments, the second polysaccharide is present in the composition in an amount of about 15%. In some embodiments, the second polysaccharide is a powder. In some embodiments, the powder has an average particle diameter of about 5 microns to about 10 microns, for example about 5 microns, about 6 microns, about 7 microns, about 8 microns, about 9 microns, about 10 microns or an average particle diameter between any of these values.

In some embodiments, at least one of the first polysaccharide and the second polysaccharide is a homopolysaccharide. In some embodiments, both the first polysaccharide and the second polysaccharide are homopolysaccharides. In some embodiments, at least one of the first polysaccharide and the second polysaccharide is a heteropolysaccharide. In some embodiments, both the first polysaccharide and the second polysaccharide are heteropolysaccharides.

In some embodiments, at least one of the first polysaccharide and the second polysaccharide is biomass-derived. In some embodiments, both the first polysaccharide and the second polysaccharide are biomass-derived. In some embodiments, at least one of the first polysaccharide and the second polysaccharide is a food gum. In some embodiments, both the first polysaccharide and the second polysaccharide are a food gum. In some embodiments, at least one of the first polysaccharide and the second polysaccharide is a derivative of at least one of arabic gum, locust bean gum, guar gum, carrageenan, konjac glucomannan, flaxseed gum, tamarind gum, or combinations thereof. In some embodiments, both the first polysaccharide and the second polysaccharide are derivatives of at least one of arabic gum, locust bean gum, guar gum, carrageenan, konjac glucomannan, flaxseed gum, tamarind gum, or combinations thereof.

In some embodiments, the first polysaccharide is present in the composition in an amount of about 5% to about 25% by mass, for example about 5%, about 10%, about 15%, about 20%, about 25% by mass or a percentage by mass between any of these values, and the second polysaccharide is present in the composition in an amount of about 5% to about 25% by mass, for example about 5%, about 10%, about 15%, about 20%, about 25% by mass or a percentage by mass between any of these values. In some embodiments, the first polysaccharide and the second polysaccharide are present in the composition in a molar ratio of about 1:1. In some embodiments, the first polysaccharide and the second polysaccharide are present in the composition in a molar ratio of about 0.8:1.

In some embodiments, at least one of the first polysaccharide and the second polysaccharide is a powder. In some embodiments, both the first polysaccharide and the second polysaccharide are a powder. In some embodiments, the powder has an average particle diameter of about 5 microns to about 10 microns, for example, about 5 microns, about 6 microns, about 7 microns, about 8 microns, about 9 microns, about 10 microns or an average particle diameter between any of these values.

In some embodiments, at least one reinforcing material is present in the composition. Any type of reinforcing material may be used in the embodiments described herein, for instance, but not limited to, materials derived from wheat, rice, corn, potatoes, oilseeds, cotton, sugar cane, and other crops. In some embodiments, the at least one reinforcing material is a wheat straw powder. In some embodiments, the at least one reinforcing material is present in the composition in an amount of about 40% to about 70% by mass, for example about 40%, about 45%, about 50%, about 55%, about 60%, about 65%, about 70%, about 75% by mass or a percentage by mass between any of these values. In some embodiments, the at least one reinforcing material is present in the composition in an amount of about 45% to about 50% by mass. In some embodiments, the at least one reinforcing material has an average particle diameter of about 10 microns to about 100 microns, for example, about 10 microns, about 20 microns, about 30 microns, about 40 microns, about 50 microns, about 60 microns, about 70 microns, about 80 microns, about 90 microns, about 100 microns, or an average particle diameter between any of these values. In some embodiments, the at least one fiber reinforcing material has an average particle diameter of about 10 microns to about 30 microns.

In some embodiments, at least one curing accelerator is present in the composition. In some embodiments, the curing accelerator includes an imidazole catalyst, a tertiary amine catalyst, an organotin, or combinations thereof. In some embodiments, the curing accelerator includes dimethylimidazole. In some embodiments, the at least one curing accelerator is present in the composition in an amount of about 0.5% to about 5% by mass, for example about 0.5%, about 1.0%, about 1.5%, about 2.5%, about 3%, about 3.5%, about 4%, about 4.5%, about 5% by mass or a percentage by mass between any of these values. In some embodiments, the at least one curing accelerator is present in the composition in an amount of about 2.5% by mass.

In some embodiments, at least one coupling agent is present in the composition. In some embodiments, the coupling agent includes a silane coupling agent, a titanate coupling agent, an isocyanate silane coupling agent, an acrylic silane coupling agent, an epoxy silane coupling agent, a carboxylic acid coupling agent, or combinations thereof. In some embodiments, the coupling agent includes glycidoxypropyltrimethoxysilane. In some embodiments, the at least one coupling agent is present in the composition in an amount of about 0.1% to about 5% by mass, for example about 0.5%, about 1.0%, about 1.5%, about 2.5%, about 3%, about 3.5%, about 4%, about 4.5%, about 5% by mass or a percentage by mass between any of these values. In some embodiments, the at least one coupling agent is present in the composition in an amount of about 2.5% by mass.

In some embodiments, a composition includes (1) a first polysaccharide having at least one substituent selected from —(CH₂)ₚO—X and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10, and (2) a second polysaccharide having at least one substituent selected from —(CH₂)ₛO—Y and —O—(CH₂)ₜ—Y, wherein Y is

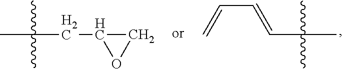

each s is independently an integer of 0, 1, 2, 3, 4, 5, 6, 7, 8, 9, or 10, and each t is independently an integer of 0, 1, 2, 3, 4, 5, 6, 7, 8, 9, or 10; wherein the first polysaccharide and the second polysaccharide are coupled to each other through at least one crosslink formed between at least one X and at least one Y.

In some embodiments, a composition includes (1) a first polysaccharide having at least one substituent selected from —(CH₂)ₚO—X and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10, (2) a second polysaccharide having at least one substituent selected from —(CH₂)ₛO—Y and —O—(CH₂)ₜ—Y, wherein Y is

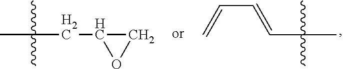

each s is independently an integer of 0, 1, 2, 3, 4, 5, 6, 7, 8, 9, or 10, and each t is independently an integer of 0, 1, 2, 3, 4, 5, 6, 7, 8, 9, or 10; wherein the first polysaccharide and the second polysaccharide are coupled to each other through at least one crosslink formed between at least one X and at least one Y, and (3) at least one of the following: at least one fiber reinforcing material, at least one curing accelerator, at least one coupling agent, or combinations thereof.

In some embodiments, a method of preparing a biomass composition includes contacting a first polysaccharide including at least one substituent selected from —(CH₂)ₚO—X and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10, and a second polysaccharide including at least one substituent selected from —(CH₂)ₛO—Y and —O—(CH₂)ₜ—Y, wherein Y is

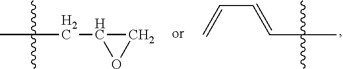

each s is independently an integer of 0, 1, 2, 3, 4, 5, 6, 7, 8, 9, or 10, and each t is independently an integer of 0, 1, 2, 3, 4, 5, 6, 7, 8, 9, or 10, to form a starting material; heating the starting material, wherein the heating causes the first polysaccharide to couple to the second polysaccharide through at least one crosslink formed between at least one X and at least one Y; and adding at least one reinforcing material, at least one curing accelerator, and at least one coupling agent, resulting in the formation of a biomass composition. The contacting may be accomplished by any suitable means, including mixing, stirring, combining, shaking, agitation, and the like. In some embodiments, the starting material is heated to a temperature of about 130° C. to about 160° C. In some embodiments, the starting material is heated to a temperature of about 150° C. In some embodiments, the starting material is heated to a temperature of about 130° C., about 135° C., about 140° C., about 145° C., about 150° C., about 155° C., about 160° C., or to any temperature or range of temperatures between 130° C. and 160° C., inclusive. In some embodiments, the starting material is heated for about 1 minute to about 5 minutes. In some embodiments, the heating step includes hot-pressing. In some embodiments, the hot pressing is performed by a thermocompressor. In some embodiments, the thermocompressor is coated with a demoulding agent. In some embodiments, the method further includes manufacturing a food packaging material using the biomass composition. In some embodiments, the food packaging material is biodegradable. In some embodiments, the food packaging material substantially degrades in about 20 weeks to about 30 weeks. As used herein, “substantially degrades” means that the material can totally biodegrade in about 20 weeks to about 30 weeks.

In an embodiment, an article is made from a composition including (1) a first polysaccharide including at least one substituent selected from —(CH₂)ₚO—X and —O—(CH₂)_{q}—X, wherein X is —COOH, —NH₂, or C₂-C₁₀ alkenyl, each p is independently an integer of 0, 1, 2, 3, 4, 5, 6, 7, 8, 9, or 10, and each q is independently an integer of 0, 1, 2, 3, 4, 5, 6, 7, 8, 9, or 10, and (2) a second polysaccharide comprising at least one substituent selected from —(CH₂)ₛO—Y and —O—(CH₂)ₜ—Y, wherein Y is

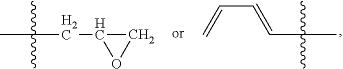

each s is independently an integer of 0, 1, 2, 3, 4, 5, 6, 7, 8, 9, or 10, and each t is independently an integer of 0, 1, 2, 3, 4, 5, 6, 7, 8, 9, or 10; wherein the first polysaccharide and the second polysaccharide are coupled to each other through at least one crosslink formed between at least one X and at least one Y. In some embodiments, the article is a packaging material. In some embodiments, the article is a container. In some embodiments, the article is used for packaging food. In some embodiments, the article is used for mulch plastic films.

In some embodiments, the composition is a resin. In some embodiments, the composition is a thermosetting resin. In some embodiments, the composition has a tensile strength of about 10 MPa to about 25 MPa, for example about 10 MPa, about 11 MPa, about 12 MPa, about 13 MPa, about 14 MPa, about 15 MPa, about 16 MPa, about 17 MPa, about 18 MPa, about 19 MPa, about 20 MPa, about 21 MPa, about 22 MPa, about 23 MPa, about 24 MPa, about 25 MPa, or a tensile strength between any of these values. In some embodiments, the composition substantially degrades in less than or equal to about 60 weeks. In some embodiments, the composition substantially degrades in about 20 weeks to about 30 weeks.

In some embodiments, the compound is used to make shaped articles. Shaped articles may be made using any technique, for instance but not limited to casting, molding, injection molding, extrusion, and the like.

### Examples

### Example 1: Preparation of a Resin

A resin was prepared by coupling a first functional group onto the side chain of a polysaccharide of a first biomass material, coupling a second functional group onto the side chain of a polysaccharide of a second biomass material, and crosslinking at least one of the functional groups on the first biomass material to at least one of the functional groups on the second biomass material.

A —CH₂—COOH functional group was coupled onto guar gum using chloroacetic acid as a modifier. The number of the —CH₂—COOH functional groups bonded to the polysaccharide was controlled by adjusting the feed ratio of the chloroacetic acid and guar gum. Tert-butylamine R3N was added as a catalyst to couple the —CH₂—COOH functional groups onto the polysaccharide. The molar ratio of hydroxyl groups in the polysaccharide compound to chloroacetic acid was about 1:1. The amount of catalyst used was about 0.1% of the polysaccharide compound. The reaction was carried out at about 65° C. for about 10 hours.

A

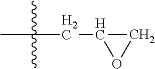 [SMILES: *CC1CO1]

functional group was coupled onto guar gum using chloro-propylene oxide as a modifier. Tert-butylamine was added as a catalyst to couple the

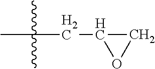 [SMILES: *CC1CO1]

functional groups onto the polysaccharide. The molar ratio of hydroxyl groups in the polysaccharide compound to chloro-propylene oxide was about 1:2.5. The amount of catalyst used was about 0.1% of the polysaccharide compound. The reaction was carried out at about 65° C. for about 6 hours.

The —CH₂—COOH functional groups were crosslinked to the

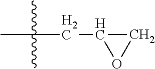 [SMILES: *CC1CO1]

functional groups.

### Example 2: Preparation of a Resin Composition

A resin composition was prepared by adding at least one reinforcing material to the resin of Example 1. Wheat straw powder having an average particle diameter of about 10 microns was mixed with the resin produced according to Example 1, dimethylimidazole, and glycidoxypropyltrimethoxysilane (KH560). The resulting mixture was then hot pressed on a thermocompressor coated with simethicone (a demoulding agent) at a temperature of about 60° C. for about 15 minutes and demoulded to form the resin composition.

Table 1 shows 8 compositions produced with varying amounts of the first polysaccharide, the second polysaccharide, wheat straw powder, dimethylimidazoline, and glycidoxypropyltrimethoxysilane, and at varying hot press temperatures and hot pressing time periods.

TABLE 1

| | | | | | Glycidoxy- | | |
|---|---|---|---|---|---|---|---|
| | | | | | propyltri- | Hot | Hot Press |
| | First Poly- | Second Poly- | Wheat Straw | Dimethyl- | methoxy- | Press | Time |
| | saccharide | saccharide | Powder | imidazoline | silane | Temp | Period |
| No. | (mass %) | (mass %) | (mass %) | (mass %) | (mass %) | (° C.) | (minutes) |
| 1 | 5 | 15 | 70 | 5 | 5 | 150 | 2 |
| 2 | 25 | 25 | 49 | 0.5 | 0.5 | 150 | 5 |
| 3 | 20 | 20 | 58.9 | 1 | 0.1 | 150 | 4.5 |
| 4 | 15 | 20 | 62 | 3 | 1 | 150 | 4 |
| 5 | 15 | 15 | 68 | 1 | 1 | 150 | 4 |
| 6 | 13 | 15 | 70 | 1.5 | 0.5 | 150 | 4.5 |
| 7 | 5 | 25 | 61 | 5 | 4 | 150 | 4.5 |
| 8 | 15 | 15 | 67 | 2 | 1 | 150 | 3.5 |

### Example 3: Preparation of a Packaging Material

The resin compositions from Example 2 were further processed to form biodegradable food packagings.

### Example 4: Mechanical Property Testing of Resin Composition

The resin compositions prepared in Example 2 were subjected to mechanical property analysis, including tensile strength and biodegradability.

Tensile Strength:

The mechanical property of the resin composition was tested by a universal tensile machine. The results of the testing showed a tensile strength of about 10-25 MPa. The pieces of material that were tested were about 80 mm long, about 10 mm wide, and about 4 mm thick.

Degradability:

The biodegradability of the resin compositions were also studied by a soil landfill method. The resin compositions were found to degrade completely within 20-30 weeks. Samples of the materials were placed in a container filled with soil and sand. The container was preserved with high humidity and without light. After a period of time, the samples were removed to determine any weight loss.

Table 2 shows the effects of modifying the biomass composition and the hot press time on the tension force and time for complete degradation of the biomass compositions of Table 1.

TABLE 2

| | | Time for |
|---|---|---|
| | Tension | Complete |
| | Force | Degradation |
| No. | (MPa) | (weeks) |
| 1 | 10 | 20 |
| 2 | 15 | 30 |
| 3 | 11 | 27 |
| 4 | 12 | 23 |
| 5 | 13.5 | 20 |
| 6 | 12.5 | 25 |
| 7 | 11.5 | 24 |
| 8 | 13.8 | 27 |

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A composition comprising:
a first polysaccharide comprising at least one substituent selected
from —(CH₂)ₚO—X and —O—(CH₂)_{q}—X, wherein
X is —COOH, —NH₂, or C₂-C₁₀ alkenyl,
each p is independently an integer of 0, 1, 2, 3, 4, 5, 6, 7, 8, 9, or 10, and
each q is independently an integer of 0, 1, 2, 3, 4, 5, 6, 7, 8, 9, or 10; and
a second polysaccharide comprising at least one substituent selected
from —(CH₂)ₛO—Y and —O—(CH₂)ₜ—Y, wherein
Y is 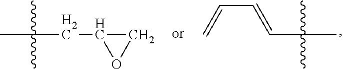
each s is independently an integer of 0, 1, 2, 3, 4, 5, 6, 7, 8, 9, or 10, and
each t is independently an integer of 0, 1, 2, 3, 4, 5, 6, 7, 8, 9, or 10;
wherein the first polysaccharide and the second polysaccharide are coupled to each other through at least one crosslink formed between at least one X and at least one Y.

2. The composition of claim 1, wherein X is —COOH.

3. The composition of claim 1, wherein Y is

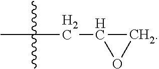 [SMILES: *CC1CO1]

4. The composition of claim 1, wherein X is —COOH and Y is

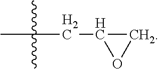 [SMILES: *CC1CO1]

5. The composition of claim 1, wherein the first polysaccharide is of formula (I): 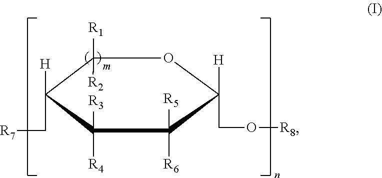
wherein each R₁, R₂, R₃, R₄, R₅, R₆ and R₇ is independently selected from a polysaccharide of formula (I), a hydrogen, a hydroxyl group, a carboxyl group, an amino group, —O—, a straight or branched C₁-C₁₀ alkyl, a straight or branched C₂-C₁₀ alkenyl, a straight or branched C₂-C₁₀ alkynyl, a straight or branched C₁-C₁₀ heteroalkyl, a straight or branched C₂-C₁₀ heteroalkenyl, and a straight or branched C₂-C₁₀ heteroalkynyl, wherein each hydroxyl group, carboxyl group, amino group, —O—, straight or branched C₁-C₁₀ alkyl, straight or branched C₂-C₁₀ alkenyl, straight or branched C₂-C₁₀ alkynyl, straight or branched C₁-C₁₀ heteroalkyl, straight or branched C₂-C₁₀ heteroalkenyl, and straight or branched C₂-C₁₀ heteroalkynyl is substituted or unsubstituted;
wherein each R₈ is independently selected from a polysaccharide of formula (I), a hydrogen, a hydroxyl group, a carboxyl group, an amino group, a straight or branched C₁-C₁₀ alkyl, a straight or branched C₂-C₁₀ alkenyl, a straight or branched C₂-C₁₀ alkynyl, a straight or branched C₁-C₁₀ heteroalkyl, a straight or branched C₂-C₁₀ heteroalkenyl, and a straight or branched C₂-C₁₀ heteroalkynyl, wherein each hydroxyl group, carboxyl group, amino group, straight or branched C₁-C₁₀ alkyl, straight or branched C₂-C₁₀ alkenyl, straight or branched C₂-C₁₀ alkynyl, straight or branched C₁-C₁₀ heteroalkyl, straight or branched C₂-C₁₀ heteroalkenyl, and straight or branched C₂-C₁₀ heteroalkynyl is substituted or unsubstituted;
wherein each m is independently an integer of 0 or 1; and
wherein each n is independently an integer of 1 to 10.

6.-7. (canceled)

8. The composition of claim 5, wherein when m is 0 and R₁ and R₂ are absent.

9. The composition of claim 1, wherein the first polysaccharide is a powder, and wherein the powder has an average particle diameter of about 5 microns to about 10 microns.

10.-15. (canceled)

16. The composition of claim 1, wherein the first polysaccharide is present in the composition in an amount of about 5% to about 25% by mass.

17. The composition of claim 1, wherein the second polysaccharide is of formula (II): 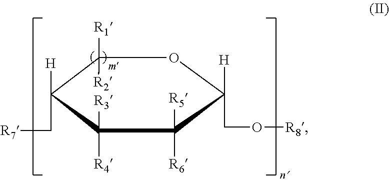
wherein each R_{1′}, R_{2′}, R_{3′}, R_{4′}, R_{5′}, R_{6′}, and R_{7′} is independently selected from a polysaccharide of formula (II), a hydrogen, a hydroxyl group, an epoxide, a (C₁-C₁₀ alkyl)-epoxide, —O—, a straight or branched C₁-C₁₀ alkyl, a straight or branched C₂-C₁₀ alkenyl, a straight or branched C₂-C₁₀ alkynyl, a straight or branched C₁-C₁₀ heteroalkyl, a straight or branched C₂-C₁₀ heteroalkenyl, and a straight or branched C₂-C₁₀ heteroalkynyl, wherein each hydroxyl group, carboxyl group, amino group, —O—, straight or branched C₁-C₁₀ alkyl, straight or branched C₂-C₁₀ alkenyl, straight or branched C₂-C₁₀ alkynyl, straight or branched C₁-C₁₀ heteroalkyl, straight or branched C₂-C₁₀ heteroalkenyl, and straight or branched C₂-C₁₀ heteroalkynyl is substituted or unsubstituted;
wherein each R_{8′} is independently selected from a polysaccharide of formula (II), a hydrogen, a hydroxyl group, an epoxide, a (C₁-C₁₀ alkyl)-epoxide, a straight or branched C₁-C₁₀ alkyl, a straight or branched C₂-C₁₀ alkenyl, a straight or branched C₂-C₁₀ alkynyl, a straight or branched C₁-C₁₀ heteroalkyl, a straight or branched C₂-C₁₀ heteroalkenyl, and a straight or branched C₂-C₁₀ heteroalkynyl, wherein each hydroxyl group, carboxyl group, amino group, straight or branched C₁-C₁₀ alkyl, straight or branched C₂-C₁₀ alkenyl, straight or branched C₂-C₁₀ alkynyl, straight or branched C₁-C₁₀ heteroalkyl, straight or branched C₂-C₁₀ heteroalkenyl, and straight or branched C₂-C₁₀ heteroalkynyl is substituted or unsubstituted;
wherein each m′ is independently an integer of 0 or 1; and
wherein each n′ is independently an integer of 1 to 10.

18.-19. (canceled)

20. The composition of claim 17, wherein when m′ is 0, R₁, and R₂ are absent.

21. The composition of claim 1, wherein the second polysaccharide is a powder, and wherein the powder has an average particle diameter of about 5 microns to about 10 microns.

22.-27. (canceled)

28. The composition of claim 1, wherein the second polysaccharide is present in the composition in an amount of about 5% to about 25% by mass.

29. The composition of claim 1, wherein the first polysaccharide and the second polysaccharide are present in the composition in a molar ratio of about 1:1.

30. (canceled)

31. The composition of claim 1, wherein at least one of the first polysaccharide and the second polysaccharide is a homopolysaccharide.

32. The composition of claim 1, wherein at least one of the first polysaccharide and the second polysaccharide is a heteropolysaccharide.

33. The composition of claim 1, wherein at least one of the first polysaccharide and the second polysaccharide is biomass-derived, or a food gum.

34.-35. (canceled)

36. The composition of claim 1, further comprising at least one reinforcing material, wherein the at least one reinforcing material is a wheat straw powder.

37. (canceled)

38. The composition of claim 36, wherein the at least one reinforcing material has an average particle diameter of about 10 microns to about 100 microns, and wherein the at least one reinforcing material is present in the composition in an amount of about 40% to about 70% by mass.

39.-41. (canceled)

42. The composition of claim 1, further comprising at least one curing accelerator, wherein the at least one curing accelerator comprises an imidazole catalyst, a tertiary amine catalyst, an organotin, or combinations thereof, and wherein the at least one curing accelerator is present in the composition in an amount of about 0.5% to about 5% by mass.

43-45. (canceled)

46. The composition of claim 1, further comprising at least one coupling agent, wherein the at least one coupling agent comprises a silane coupling agent, a titanate coupling agent, an isocyanate silane coupling agent, an acrylic silane coupling agent, an epoxy silane coupling agent, a carboxylic acid coupling agent, or combinations thereof, and wherein the at least one coupling agent is present in the composition in an amount of about 0.1% to about 5% by mass.

47.-50. (canceled)

51. The composition of claim 1, wherein the composition has a tensile strength of about 10 MPa to about 25 MPa.

52. The composition of claim 1, wherein the composition substantially degrades in about 20 weeks to about 30 weeks.

53. A composition comprising:
a first polysaccharide comprising at least one substituent selected from —(CH₂)ₚO—X, and —O—(CH₂)_{q}—X, wherein
X is —COOH, —NH₂, or C₂-C₁₀ alkenyl,
each p is independently an integer of 0, 1, 2, 3, 4, 5, 6, 7, 8, 9, or 10, and
each q is independently an integer of 0, 1, 2, 3, 4, 5, 6, 7, 8, 9, or 10; and
a second polysaccharide comprising at least one substituent selected from —(CH₂)ₛO—Y, and —O—(CH₂)ₜ—Y, wherein
Y is 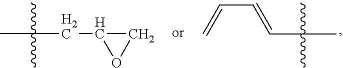
each s is independently an integer of 0, 1, 2, 3, 4, 5, 6, 7, 8, 9, or 10, and
each t is independently an integer of 0, 1, 2, 3, 4, 5, 6, 7, 8, 9, or 10;
wherein the first polysaccharide and the second polysaccharide are coupled to each other through at least one crosslink formed between at least one X and at least one Y;
at least one reinforcing material;
at least one curing accelerator; and
at least one coupling agent.

54-86. (canceled)

87. The composition of claim 53, wherein the at least one reinforcing material is a wheat straw powder.

88. The composition of claim 53, wherein the at least one reinforcing material has an average particle diameter of about 10 microns to about 100 microns, and wherein the at least one reinforcing material is present in the composition in an amount of about 45% to about 50% by mass.

89.-90. (canceled)

91. The composition of claim 53, wherein the at least one curing accelerator comprises an imidazole catalyst, a tertiary amine catalyst, an organotin, or combinations thereof.

92. (canceled)

93. The composition of claim 53, wherein the at least one coupling agent comprises a silane coupling agent, a titanate coupling agent, an isocyanate silane coupling agent, an acrylic silane coupling agent, an epoxy silane coupling agent, a carboxylic acid coupling agent, or combinations thereof.

94.-96. (canceled)

97. A method of preparing a biomass composition comprising:
contacting
a first polysaccharide comprising at least one substituent selected
from —(CH₂)ₚO—X and —O—(CH₂)_{q}—X, wherein
X is —COOH, —NH₂, or C₂-C₁₀ alkenyl,
each p is independently an integer of 0, 1, 2, 3, 4, 5, 6, 7, 8, 9, or 10, and
each q is independently an integer of 0, 1, 2, 3, 4, 5, 6, 7, 8, 9, or 10; and
a second polysaccharide comprising at least one substituent selected
from —(CH₂)ₛO—Y and —O—(CH₂)ₜ—Y, wherein
Y is 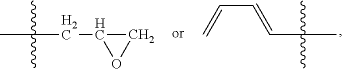
each s is independently an integer of 0, 1, 2, 3, 4, 5, 6, 7, 8, 9, or 10, and
each t is independently an integer of 0, 1, 2, 3, 4, 5, 6, 7, 8, 9, or 10 to form a starting material;
heating the starting material, wherein the heating couples the first polysaccharide to the second polysaccharide through at least one crosslink formed between at least one X and at least one Y; and
adding
at least one reinforcing material,
at least one curing accelerator, and
at least one coupling agent,
resulting in the formation of a biomass composition.

98. The method of claim 97, wherein the heating step comprises heating at a temperature of about 130° C. to about 160° C., and wherein the heating step occurs for about 1 minute to about 5 minutes.

99.-100. (canceled)

101. The method of claim 97, wherein the heating step comprises hot-pressing using a thermocompressor, and wherein the thermocompressor is coated with a demoulding agent.

102.-153. (canceled)
